(19) United States
(12) Patent Application Publication
(10) Pub. No.: US 2011/0299814 A1
(43) Pub. Date: Dec. 8, 2011

(54) DUPLEX OPTICAL CONNECTOR UNIT

(76) Inventor: Masaya NAKAGAWA, Kyoto-shi (JP)

(21) Appl. No.: 13/116,287

(22) Filed: May 26, 2011

(30) Foreign Application Priority Data
Jun. 4, 2010 (JP) 2010-128967

(51) Int. Cl. G02B 6/36

(52) U.S. Cl. 385/78

(57) ABSTRACT

Provided is a duplex optical connector unit, in which locking levers extending obliquely upward toward a proximal end side and including interlocking portions engaging with an optical adapter are provided on top surfaces of housings of optical connectors, and an operation lever extending obliquely upward toward a leading end side and including a pressing part located above the locking levers is provided in a top surface of a main body portion of a boot.

### TECHNICAL FIELD

The present invention relates to an optical connector, and more particularly, to a duplex optical connector unit for bidirectional communication including a pair of optical connectors.

### BACKGROUND ART

An optical connector is fixed to a leading end of an optical fiber, and is used for connecting the optical fiber to another optical fiber or an optical communication module via an optical adapter or an optical receptacle. A duplex optical connector unit for bidirectional communication including an input optical connector and an output optical connector (hereinafter, also simply referred to as “optical connector unit”) is known as a kind of optical connector (for example, see Patent Literature 1).

As a cable for bidirectional communication, for example, as illustrated in FIG. 8, there is known a duplex cable 101 having a spectacles-like cross-sectional shape, which is formed by integrally joining two optical fiber cables 101a, 101b. The optical fiber cables 101a, 101b each include a bare fiber 112 incorporating an optical fiber 111, and a reinforcement fiber 113 and a covering tube 114 covering an outer periphery of the bare fiber 112. An optical connector unit 100 to be connected to the duplex cable 101 having a spectacles-like cross-sectional shape includes, for example, as illustrated in FIG. 9, a pair of optical connectors 102a, 102b fixed to leading ends of the pair of optical fiber cables 101a, 101b, a holder 103 for holding the pair of optical connectors 102a, 102b, and boots 104a, 104b for protecting the pair of optical fiber cables 101a, 101b extending from the holder 103.

Such an optical connector unit 100 has a problem in that the duplex cable 101 bifurcates to the two optical fiber cables 101a, 101b, and hence the optical connector unit 100 takes a large mounting space. Further, the two boots 104a, 104b need to be provided for protecting the two bifurcated optical fiber cables 101a, 101b, resulting in increase in size of the unit, a large number of components, and increase in assembly man-hours and cost.

Further, when the optical connector unit 100 is mounted to the optical adapter, the optical connector unit 100 needs to be rotated so as to fit to a mounting portion of the optical adapter. At this time, a twist occurs in the duplex cable 101. However, the duplex cable 101 has a flat spectacles-like cross-sectional shape as illustrated in FIG. 8, and hence it is difficult to smoothly twist the duplex cable 101 particularly when the duplex cable 101 is curved. As a result, the optical connector unit 100 resists rotation, which leads to poor mounting workability. Further, when the optical connector unit is connected to each of a plurality of connection terminals provided in an appliance, a plurality of cables extending from the optical connector unit are arranged by tying the plurality of cables together. However, it is difficult to tie the duplex cables 101 together due to its spectacles-like cross-sectional shape, and thus the arrangement of the wiring is difficult. Moreover, not only is it difficult to rotate one duplex cable 101 having a spectacles-like cross-sectional shape, but also it becomes more difficult to rotate the plurality of duplex cables 101 tied together because the cables interfere with each other, which leads to poor wiring workability.

Then, in Patent Literature 2, the inventor of the present invention proposed an optical connector unit 200 as illustrated in FIG. 10. The optical connector unit 200 has a structure to which a duplex cable 201 having a substantially circular cross-sectional shape can be fixed, the duplex cable 201 being formed by providing a pair of optical fibers inside one covering tube. As illustrated in FIG. 11, the duplex cable 201 includes two bare fibers 212 incorporating optical fibers 211, a covering tube 214 covering outer peripheries of the bare fibers 212, and a reinforcement fiber 213 filled between the covering tube 214 and the bare fibers 212. As illustrated in FIG. 10, the optical connector unit 200 includes a pair of optical connectors 202a, 202b, a holder 203 for holding the pair of optical connector 202a, 202b, and a boot 204 fitted to the holder 103. The dual cable 201 is fixed to the holder 203, and the pair of optical fibers bifurcate inside the holder 203 so as to be connected to the optical connectors 202a, 202b.

According to the optical connector unit 200, the two bifurcated optical fiber cables are not exposed to the outside, and hence space saving is achieved. Further, one boot 204 is enough, and hence the unit can be downsized compared to the optical connector unit 100 as illustrated in FIG. 9 and the number of components can be reduced. Moreover, it is easy to tie the duplex cable 201 due to its substantially circular cross-sectional shape, and thus the arrangement of the wiring is easy. Further, even a curved cable or a plurality of cables tied together can be smoothly twisted. Thus, the optical connector unit 200 is rotated more easily, which facilitates wiring work.

### Citation List

Patent Literature 1: JP 2000-315821 A
Patent Literature 2: JP 2005-189288 A

### SUMMARY OF INVENTION

### Technical Problem

In the optical connector unit as described above, an input optical connector and an output optical connector are mounted to an input mounting portion and an output mounting portion of an optical adapter (or optical receptacle, the same shall apply hereinafter), respectively. Therefore, in assembling the optical connector unit, when the input optical connector and the output optical connector are reversely assembled by mistake, both the optical connectors are not adapted to the mounting portions of the optical adapter. The optical connector unit thus assembled is not usable, and hence the optical connector unit together with a duplex cable fixed thereto becomes useless.

Further, for example, in the case of the optical connector unit to be mounted to the optical adapter provided as an optical connection terminal of an electronic device, even if the optical connector unit to be connected from outside of the electronic device is correctly assembled, when the input optical connector and the output optical connector are reversely mounted to the mounting portions inside the optical adapter, it is impossible to correctly connect an optical fiber. In this case, it is possible to deal with this situation by opening a casing of the electronic device and exchanging the positions of the optical connectors inside the casing. However, work of opening the casing of the electronic device is troublesome, and hence it is desired to complete the exchange of the positions of the optical connectors on the optical connector unit side to be connected from outside of the electronic device if circumstances allow.

The above-mentioned trouble can be eliminated by exchanging the positions of a pair of optical connectors. For example, when the entire optical connector unit is reversed upside down, that is, when the optical connector unit is rotated 180 degrees about an optical axis direction (direction in which the optical fiber extends), the positions of the input optical connector and the output optical connector can be exchanged. However, for example, as illustrated in FIG. 10, in the case of the optical connectors 202a, 202b which are provided with locking levers 207a, 207b, when the optical connector unit is reversed upside down, the locking levers 207a, 207b face downward, with the result that the optical connectors cannot be mounted to the optical adapter.

Alternatively, it is conceivable that the positions of the optical connectors 202a, 202b are exchanged by steps as illustrated in FIGS. 12A to 12C. More specifically, the pair of optical connectors 202a, 202b which include the locking levers 207a, 207b facing upward (see FIG. 12A) are each reversed upside down relative to a holder 203 (see FIG. 12B), and then the entire optical connector unit 200 is reversed upside down (see FIG. 12C). However, the holder 203 of the optical connector unit 200 is provided with an operation lever 208 for pressing the locking levers 207a, 207b from above (see FIG. 10). Therefore, when the optical connectors 202a, 202b are each reversed upside down relative to the holder 203 as illustrated in FIG. 12B, the locking levers 207a, 207b and the operation lever 208 are disposed vertically on opposite sides, resulting in a defective assembly.

An object to be achieved by the present invention is to provide an optical connector unit which includes the locking levers and the operation lever and enables the pair of optical connectors to be easily exchanged in position.

### Solution to Problem

In order to achieve the above-mentioned object, the present invention provides a duplex optical connector unit, which is fixed to a leading end of a duplex cable including a pair of optical fibers therein, including: a pair of optical connectors, each of which includes a ferrule provided to a leading end of each of the pair of optical fibers, a housing for holding the ferrule, and a locking lever extending obliquely upward from a top surface of the housing toward a proximal end side, the pair of optical connectors each being provided at the leading end of each of the pair of optical fibers; a holder, which includes connector fixing portions for fixing the pair of optical connectors, and a cable fixing portion for fixing the duplex cable; and a boot, which includes a main body portion fitted to the holder and covering an outer periphery of the duplex cable, an operation lever extending obliquely upward from a top surface of the main body portion toward a leading end side, and a pressing part provided in the operation lever and located above the locking lever.

Note that, in the description of the optical connector unit, a direction in which the optical fiber of each of the optical connectors is referred to as an “optical axis direction” (X direction of FIG. 1), a direction in which the pair of optical connectors are aligned in parallel is referred to as a “width direction” (Y direction of FIG. 1), and a direction orthogonal to the width direction and the optical axis direction is referred to as an “up-down direction” (Z direction of FIG. 1). However, those directions are defined for convenience of description, and not intended to limit an aspect of usage of the optical connector unit.

In this way, in the optical connector unit of the present invention, the locking lever extending obliquely upward toward the proximal end side is provided in the top surface of the housing of each of the optical connectors, and the operation lever extending obliquely upward toward the leading end side and including the pressing part located above the locking lever is provided on the top surface of the main body portion of the boot. According to the optical connector unit, the pair of optical connectors can be easily exchanged in position. More specifically, the boot is detached from the holder (see FIG. 5), the optical connectors are each reversed upside down relative to the holder while the boot is reversed upside down relative to the holder (see FIG. 6), and then the boot is placed back over the holder (see FIG. 7), thereby being capable of exchanging the positions of the pair of optical connectors under a state in which the locking levers and the operation lever are in the same orientation.

In the optical connector unit as described above, the pair of optical connectors are in a state in which the locking levers are in the same orientation (upward orientation). However, when the optical connectors are rotated relative to the holder, orientations of the pair of locking levers may be displaced and the optical connector unit may not be able to be mounted to the optical adapter. For example, if the holder includes a rotation restricting portion for restricting rotation of the optical connectors, it is possible to keep the locking levers in the same orientation. However, in this case, when reversing the pair of optical connectors upside down relative to the holder as described above, each of the optical connectors needs to be once detached from the holder. Work of detaching the optical connectors from the holder in this way is troublesome and may cause the damages of the optical fibers during the detaching work.

Thus, if the boot includes a rotation restricting portion for restricting the rotation of the optical connectors relative to the holder, it is unnecessary to provide the rotation restricting portion on the holder. As a result, the optical connectors can be rotated relative to the holder by detaching the boot from the holder and disengaging the rotation restricting portion and the locking levers (see FIG. 5). Therefore, the optical connectors each can be easily reversed upside down while being mounted in the holder. For example, the operation lever may include interlocking portions which engage with the locking lever on both sides in the width direction, and the interlocking portions may function as the rotation restricting portion.

### Advantageous Effects of Invention

As described above, in contrast to an operation lever which has been provided in a holder in a conventional product, according to the present invention, the operation lever is provided in a boot, thereby being capable of easily exchanging positions of a pair of optical connectors. As a result, even when the pair of optical connectors are reversely mounted by mistake during assembly, the optical connectors can be exchanged back into correct positions in use, and hence the optical connector unit and a duplex cable can be used without waste.

### BRIEF DESCRIPTION OF DRAWINGS

FIG. 1A perspective view illustrating an optical connector unit according to an embodiment of the present invention.

FIG. 2 A cross-sectional view illustrating the optical connector unit.

FIG. 3A A perspective view illustrating a holder of the optical connector unit.

FIG. 3B A perspective view illustrating the holder.

FIG. 3C A plan view illustrating the holder.

FIG. 3D A side view illustrating the holder seen from the direction D of FIG. 3C.

FIG. 3E A side view illustrating the holder seen from the direction E of FIG. 3C.

FIG. 3F A cross-sectional view illustrating the holder.

FIG. 4A A perspective view illustrating a boot of the optical connector unit.

FIG. 4B A perspective view illustrating the boot.

FIG. 4C A plan view illustrating the boot.

FIG. 4D A side view illustrating the boot seen from the direction D of the FIG. 4C.

FIG. 4E A side view illustrating the boot seen from the direction E of the FIG. 4C.

FIG. 5 A perspective view illustrating a step of exchanging a pair of optical connectors of the optical connector unit (a state in which the boot is detached).

FIG. 6 A perspective view illustrating a step of exchanging the pair of optical connectors of the optical connector unit (a state in which the optical connectors and the boot are reversed upside down).

FIG. 7 A perspective view illustrating a step of exchanging the pair of optical connectors of the optical connector unit (a state in which the boot is refitted).

FIG. 8 A cross-sectional view illustrating a duplex cable having a spectacles-like cross-sectional shape.

FIG. 9 A plan view schematically illustrating a conventional optical connector unit.

FIG. 10 A perspective view illustrating a conventional optical connector unit.

FIG. 11 Across-sectional view illustrating a duplex cable having a substantially circular cross-sectional shape.

FIG. 12A A side view (front view) illustrating the optical connector unit of FIG. 10.

FIG. 12B A side view (front view) illustrating the pair of optical connectors of FIG. 12A, each of which is reversed upside down.

FIG. 12C Aside view (front view) illustrating the entire optical connector unit of the FIG. 12B reversed upside down.

### DESCRIPTION OF EMBODIMENT

Hereinafter, an embodiment of the present invention is described with reference to the drawings.

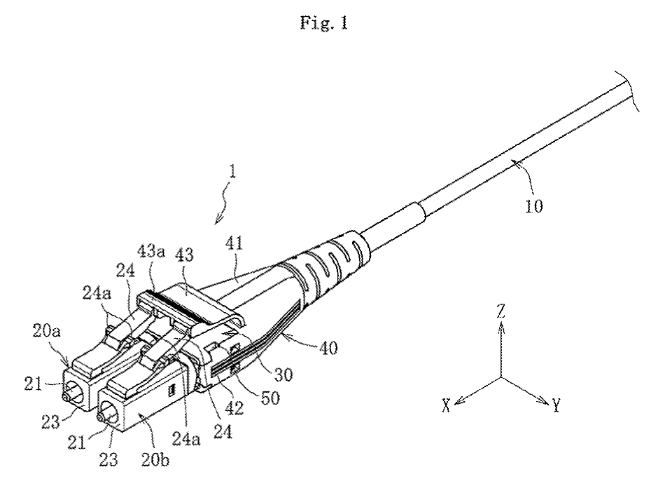

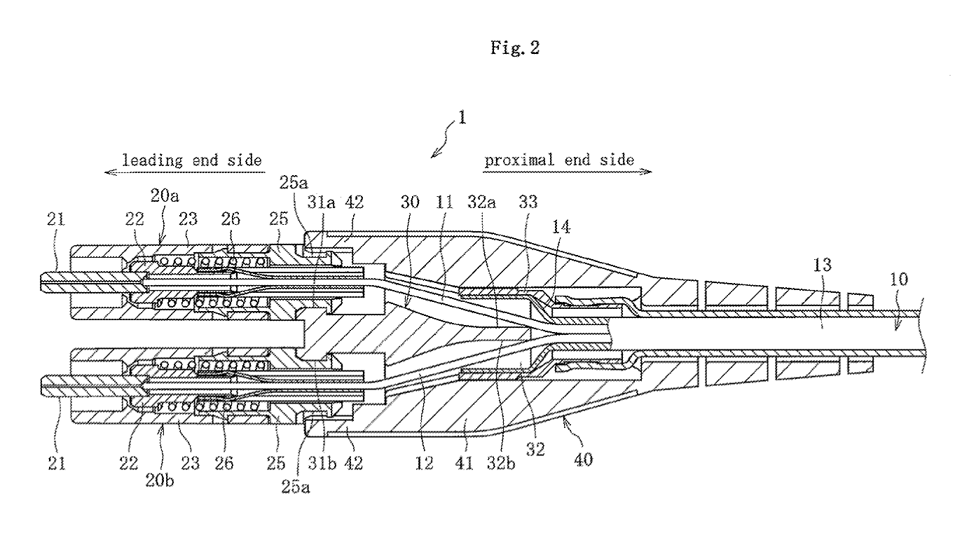

As illustrated in FIG. 1, an optical connector unit 1 according to the embodiment of the present invention is fixed to a leading end of a duplex cable 10. The duplex cable 10 includes a pair of optical fibers therein. In this embodiment, as illustrated in FIG. 2, the duplex cable 10 includes a pair of bare fibers 11, 12 incorporating the optical fibers, a covering tube 13 which covers outer peripheries of the pair of bare fibers 11, 12 so as to hold them together, and a reinforcement fiber 14 filled between the bare fibers 11, 12 and the covering tube 13. The duplex cable 10 has a substantially circular cross-sectional shape, similarly to the duplex cable 201 illustrated in FIG. 11.

The optical connector unit 1 is mounted into a mounting hole of an optical adapter (not shown). The optical connector unit 1 mainly includes an input optical connector 20a, an output optical connector 20b, a holder 30, and a boot 40. Note that, in the illustrated example, a right-left direction of FIG. 2 is referred to as an “optical axis direction”, an up-down direction of FIG. 2 is referred to as a “width direction”, and a direction orthogonal to the drawing sheet of FIG. 2 is referred to as an “up-down direction”. Further, an optical adapter side in the optical axis direction (left side of FIG. 2) is referred to as a leading end side, and the opposite side thereof (right side of FIG. 2) is referred to as a proximal end side.

The optical connectors 20a, 20b are both an LC type connector and fixed to the leading ends of the bare fibers 11, 12, respectively (see FIG. 2). The input optical connector 20a and the output optical connector 20b have a similar configuration. The optical connectors 20a, 20b each include a ferrule 21 fixed to the leading end of the bare fiber 11 or 12, a flange part 22 fixed at a proximal end portion of the ferrule 21, a housing 23 holding the ferrule 21 within its inner periphery, a locking lever 24 provided in a top surface of the housing 23, and a cap 25 provided in a proximal end portion of the housing 23.

The ferrule 21 includes an insertion hole formed therein, for inserting the optical fiber (not shown) of the bare fiber 11 or 12. A spring 26 is mounted in a compressed state in the optical axis direction between the flange part 22 and the cap 25. The spring 26 applies an elastic force to bias the ferrule 21 to the leading end side. The cap 25 includes an annular groove 25a formed in its outer peripheral surface.

As illustrated in FIG. 1, the housing 23 has a substantially rectangular parallelepiped shape, and includes a through-hole formed therein in the optical axis direction. The ferrule 21, the flange part 22, the spring 26, and the bare fiber 11 or 12 are contained in the through-hole.

The locking lever 24 extends obliquely upward from the top surface of the housing 23 toward the proximal end side and is elastic in the up-down direction. In this embodiment, the locking lever 24 and the housing 23 are integrally molded. The locking lever 24 includes a interlocking portion 24a in its middle portion. The interlocking portion 24a is engaged, in the optical axis direction, with a locking groove (not shown) provided in the optical adapter, to thereby prevent the optical connector 20a or 20b from coming off the optical adapter.

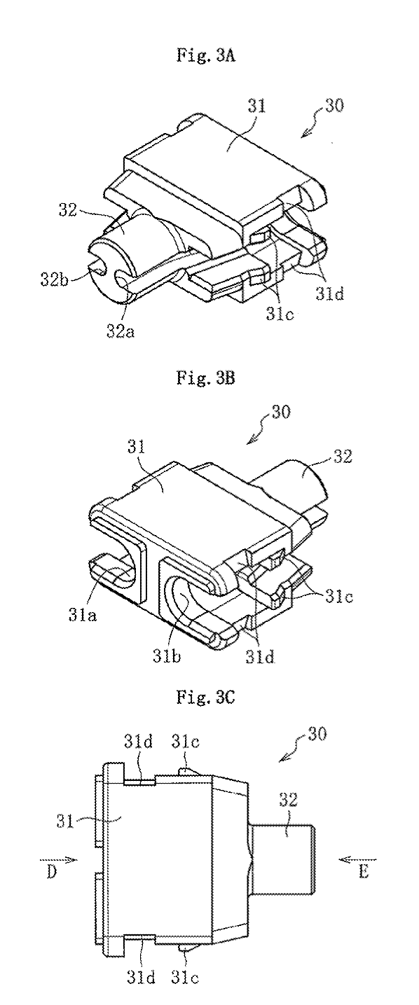

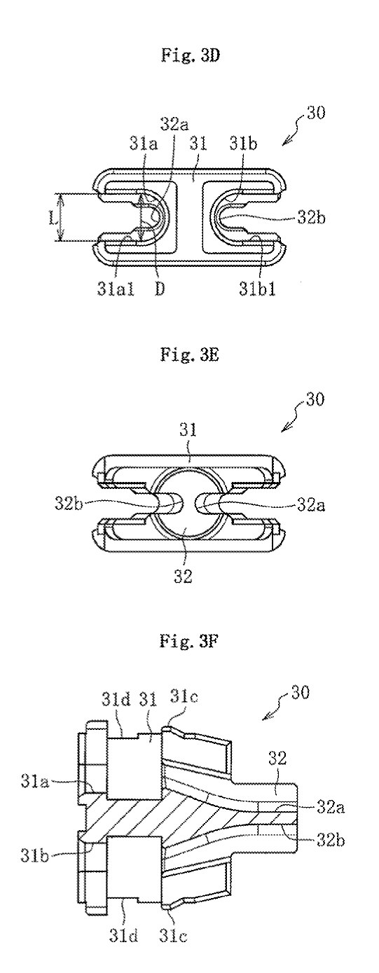

As illustrated in FIGS. 3A and 3B, the holder 30 includes, a main body portion 31 and a cable fixing portion 32 protruding from the main body portion 31 toward the proximal end side. The holder 30 has a symmetrical shape in the up-down direction and the right-left direction. The main body portion 31 has a substantially rectangular shape in plan view, and is provided with connector fixing portions 31a, 31b for fixing the optical connectors 20a, 20b (see FIGS. 3B and 3D). The connector fixing portions 31a, 31b have an arcuate shape, and are open on their outer sides in the width direction in side surfaces of the main body portion 31. The annular grooves 25a of the caps 25 of the optical connectors 20a, 20b are fitted to the connector fixing portions 31a, 31b (see FIG. 2). The connector fixing portions 31a, 31b have openings 31a1, 31b1, which have a dimension L in the up-down direction (see FIG. 3D) set to be slightly smaller than an outer diameter of the annular grooves 25a. Further, the connector fixing portions 31a, 31b have an inner diameter D which is set to be slightly larger than the outer diameter of the annular grooves 25a.

The optical connectors 20a, 20b are fitted to the holder 30 as follows. First, the annular grooves 25a of the optical connectors 20a, 20b are pressed into the openings 31a1, 31b1 from the outside in the width direction, to thereby elastically expand the openings 31a1, 31b1 up and down. When the annular grooves 25a reach the connector fixing portions 31a, 31b, the openings 31a1, 31b1 elastically recover their original shapes to complete the fitting. At this time, the annular grooves 25a and the connector fixing portions 31a, 31b are engaged with each other in the optical axis direction, to thereby cause the optical connectors 20a, 20b to be positioned in the optical axis direction relative to the holder 30. Further, the optical connectors 20a, 20b are positioned in the width direction relative to the holder 30 due to the fact that the openings 31a1, 31b1 of the connector fixing portions 31a, 31b have the dimension D in the up-down direction which is slightly smaller than the outer diameter of the annular grooves 25a. Further, the optical connectors 20a, 20b are allowed to rotate relative to the holder 30 due to the fact that the connector fixing portions 31a, 31b have the inner diameter D which is slightly larger than the outer diameter of the annular grooves 25a.

The main body portion 31 is provided with protrusions 31c on both side surfaces in the width direction, and recessed portions 31d are formed on the leading end side of the protrusions 31c (see FIGS. 3A to 3C). In the illustrated example, on each side surface of the main body portion 31, there are provided a pair of protrusions 31c, 31c and a pair of recessed portions 31d, 31d spaced apart from each other in the up-down direction.

The cable fixing portion 32 has a substantially cylindrical shape, and includes guide grooves 32a, 32b formed on its both sides in the width direction, for guiding the bare fibers 11, 12 (see FIGS. 3A and 3E). The guide grooves 32a, 32b are curved outward in the width direction so as to extend away from each other toward the leading end side and extend into the main body portion (see FIG. 3F).

As illustrated in FIG. 2, the bare fibers 11, 12 are respectively contained in the guide grooves 32a, 32b formed in the cable fixing portion 32 of the holder 30. The outer periphery of the cable fixing portion 32 is covered by the reinforcement fiber 14. A caulking member 33 is placed over the outer periphery of the cable fixing portion 32 and the reinforcement fiber 14, and the outer periphery of the caulking member 33 is fixedly caulked, thereby fixing the duplex cable 10 to the holder 30. In this way, the reinforcement fiber 14 of the duplex cable 10 is fixed to the cable fixing portion 32 of the holder 30. Thus, even when the duplex cable 10 is subjected to a tension, the tension can be borne by the reinforcement fiber 14 and the caulking member 33, and hence it is possible to avoid a risk of the tension acting directly on the bare fibers 11, 12 to cause damages of the optical fibers.

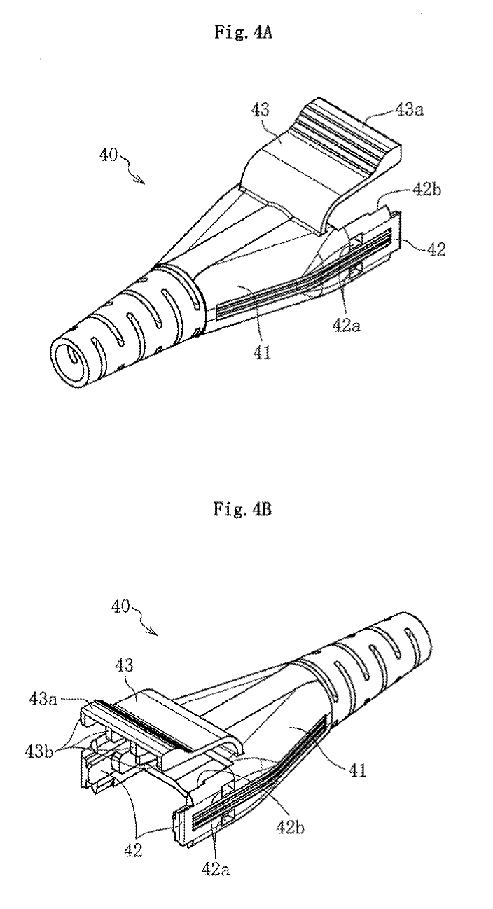

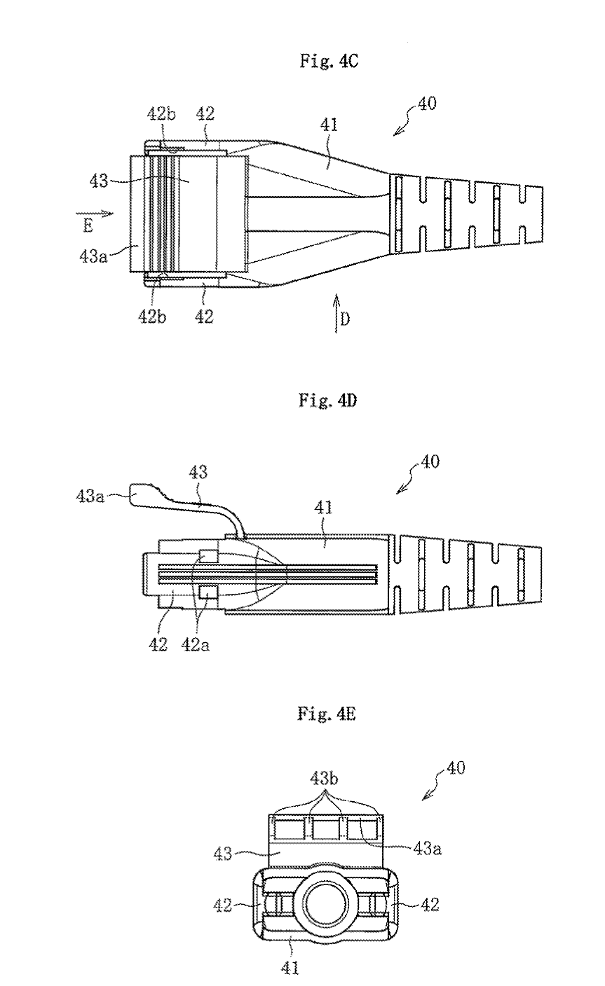

The boot 40 is formed of a flexible material (for example, elastomer). As illustrated in FIGS. 4A and 4B, the boot 40 integrally includes, a tubular main body portion 41 which narrows toward the proximal end side, a pair of fixing portions 42 which extend from both ends in the width direction of a leading end portion of the main body portion 41, and an operation lever 43 which is provided in a top surface of the main body portion 41. As illustrated in FIG. 2, the main body portion 41 covers the outer periphery of the duplex cable 10 extending from the cable fixing portion 32 of the holder 30 to the proximal end side. The elastic force of the boot 40 prevents the duplex cable 10 from being sharply folded in the vicinity of the proximal end portion of the cable fixing portion 32, and hence it is possible to prevent the damages of the optical fibers in the bare fibers 11, 12.

The fixing portions 42 each include fitting holes 42a formed therein, for fitting the protrusions 31c of the main body portion 31 of the holder 30 (see FIGS. 4A, 4B, and 4D). Further, the fixing portions 42 each include a cutout 42b formed therein on the leading end side of the fitting holes 42a (see FIG. 4C). When the boot 40 is placed over the holder 30, the protrusions 31c of the holder 30 are fitted into the fitting holes 42a of the boot 40, and the protrusions 31 and the fitting holes 42a engage with each other in the optical axis direction. Therefore, the holder 30 is prevented from coming off the boot 40. Further, the cutouts 42b of the boot 40 and the recessed portions 31d of the holder 30 cooperatively form gaps 50 (see FIG. 1). The protrusions 31c and the fitting holes 42a can be disengaged from each other by inserting a jig or the like (not shown) in the gaps 50 so as to elastically deform the fixing portions 42 of the boot 40 outward in the width direction. Therefore, it is possible to easily separate the boot 40 and the holder 30 from each other.

As illustrated in FIG. 4D, the operation lever 43 extends obliquely upward from the top surface of the main body portion 41 toward the leading end side. The operation lever 43 includes a leading end portion which is provided above proximal end portions of the locking levers 24, 24 of the pair of optical connectors 20a, 20b (see FIG. 1). The leading end portion functions as a pressing part 43a for downwardly pressing the pair of locking levers 24, 24. When the operation lever 43 is downwardly pressed to be elastically deformed, the pressing part 43a of the operation lever 43 downwardly presses the proximal end portions of the pair of locking levers 24, 24 altogether, to thereby elastically deform the locking levers 24, 24. This causes the interlocking portions 24a, 24a of the locking levers 24, 24 to be disengaged from the locking groove of the optical adapter (not shown), with the result that the optical connector unit 1 can be detached from the optical adapter. Note that, the boot 40 may have a mark, a letter, and the like on its surface (for example, on a top surface of the operation lever 42) for explicitly indicating which one of the pair of optical connectors 20a, 20b is used for input and which one is used for output.

The boot 40 is provided with a rotation restricting portion for restricting rotation of the optical connectors 20a, 20b relative to the holder 30. In this embodiment, the operation lever 43 is provided with interlocking portions 43b which engage with the locking levers 24 in the width direction, and the interlocking portions 42b function as the rotation restricting portion. Specifically, as illustrated in FIGS. 4B and 4E, there are provided a plurality of (in the illustrated example, four) interlocking portions 43b downwardly protruding from the leading end portion (pressing part 43a) of the operation lever 43. The proximal end portion of the locking lever 24 is fitted between a pair of interlocking portions 43b, 43b in the width direction. The interlocking portions 43b and the locking lever 24 engage with each other in a rotational direction, to thereby restrict the rotation of the locking lever 24, resulting in restriction of the rotation of each of the optical connectors 20a, 20b relative to the holder 30.

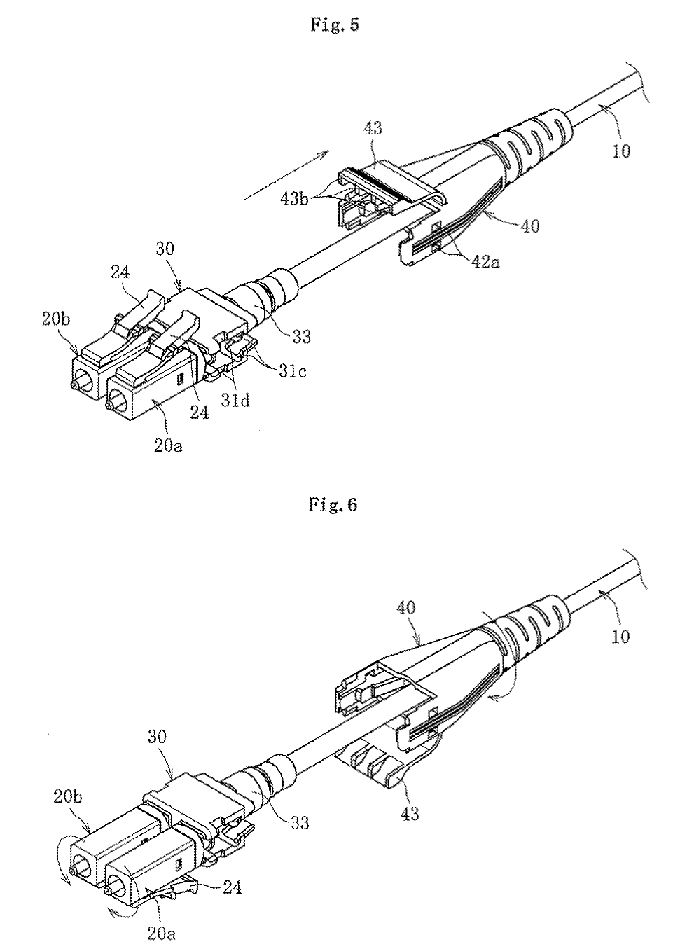

In the optical connector unit 1 having the configuration described above, the optical connectors 20a, 20b can be easily exchanged. Hereinafter, specific steps of exchanging the optical connectors 20a, 20b are described with reference to FIGS. 5 to 7.

In the optical connector unit into which the pair of optical connectors 20a, 20b are reversely assembled relative to the correct positions (see FIG. 1), first, as illustrated in FIG. 5, the boot 40 is detached from the holder 30. Specifically, the jig or the like is inserted into the gaps 50 (see FIG. 1), which are formed between the boot 40 and the holder 30, so as to elastically deform the fixing portions 42 of the boot 40 outward in the width direction, thereby causing the protrusions 31c of the holder 30 and the fitting holes 42a of the boot 40 to be disengaged from each other. In this state, the boot 40 is retracted to the proximal end side (see an arrow of FIG. 5), thereby separating the boot 40 and the holder 30 from each other. As a result, the interlocking portions 43b of the operation lever 43 of the boot 40 and the locking levers 24, 24 of the optical connectors 20a, 20b are disengaged from each other, and hence the optical connectors 20a, 20b become rotatable relative to the holder 30.

Next, as illustrated in FIG. 6, the optical connectors 20a, 20b each are rotated relative to the holder 30 so as to be reversed upside down. Along with this, the boot 40 is rotated relative to the holder 30 so as to be reversed upside down. Note that, instead of rotating the optical connectors 20a, 20b under a state in which the optical connectors 20a, 20b are fitted to the holder 30 as described above, the optical connectors 20a, 20b may be once detached from the holder 30 and reversed upside down, and then fitted back to the holder 30. However, in this case, detaching and fitting the optical connectors 20a, 20b is troublesome and there is a fear of the damages of the optical fibers during the detaching and fitting work. Thus, it is preferred that the optical connectors 20a, 20b be rotated under a state in which the optical connectors 20a, 20b are fitted to the holder 30 as described above.

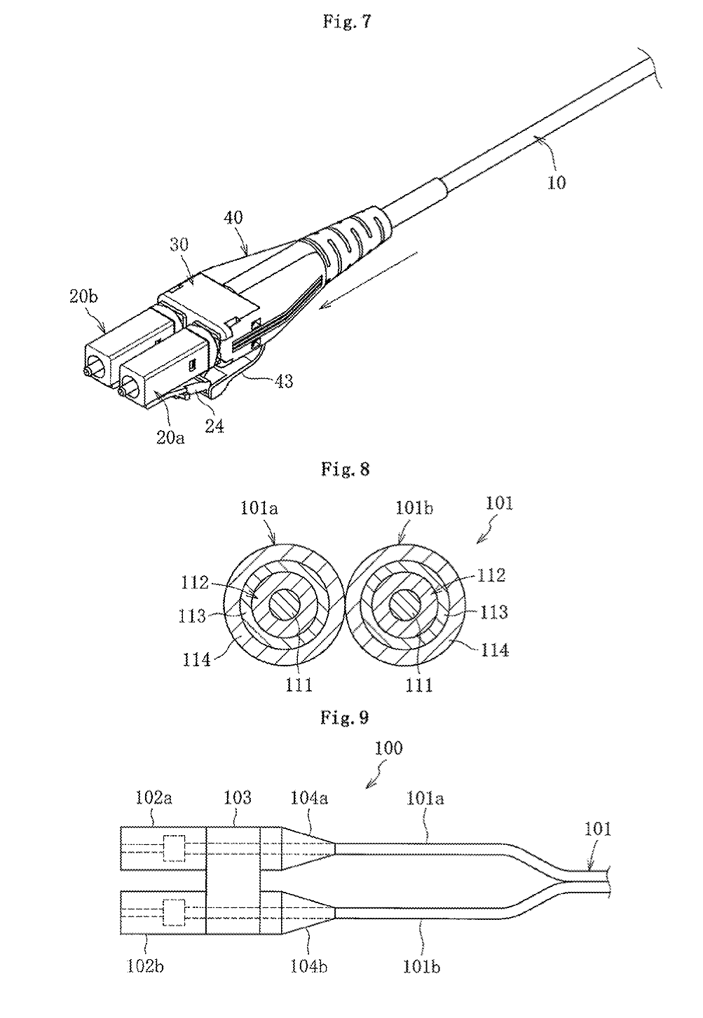

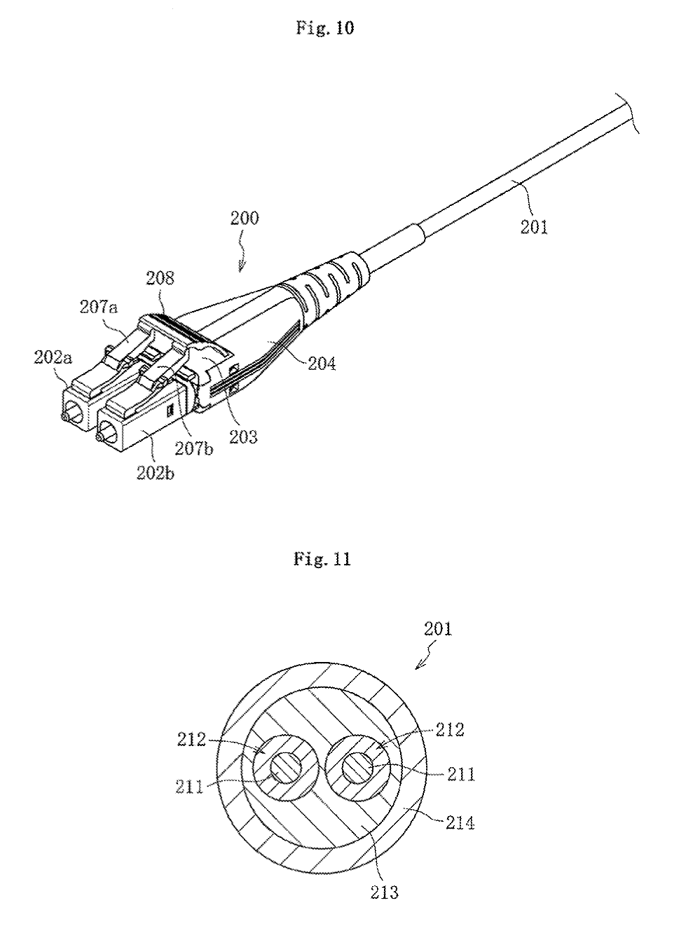

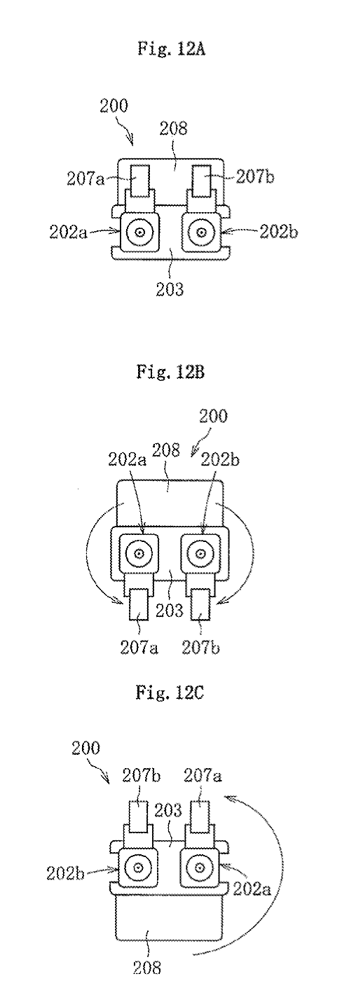

In this state, as illustrated in FIG. 7, the boot 40 is placed over the holder 30, and the protrusions 31c of the holder 30 are fitted into the fitting holes 42a of the boot 40. Then, the entire optical connector unit 1 is reversed upside down, thereby enabling the optical connectors 20a, 20b to be located in the correct positions (see FIG. 1).

Note that, in the exchanging work of the optical connectors 20a, 20b described above, the holder 30 is reversed upside down after the exchanging work. In this embodiment, the holder 30 has a vertically symmetrical shape, and hence the optical connector unit 1 has the same shape before and after the exchanging work. Thus, the optical connector unit 1 after the exchanging work can be fitted to the optical adapter without any problem.

The present invention is not limited to the above-mentioned embodiment. For example, in the above-mentioned embodiment, the operation lever 43 is provided with the rotation restricting portion (interlocking portions 43b) for restricting the rotation of the optical connectors 20a, 20b relative to the holder 30, but the present invention is not limited thereto. For example, the fixing portions 42 of the boot 40 may be extended to the leading end side so as to be held in contact with side surfaces on the outside in the width direction of the optical connectors 20a, 20b, thereby restricting the rotation of the optical connectors 20a, 20b.

Alternatively, the holder 30 may be provided with a rotation restricting portion. In this case, even under a state in which the boot 40 is detached from the holder 30, the optical connectors 20a, 20b cannot be rotated. Therefore, the optical connectors 20a, 20b need to be reversed upside down relative to the holder 30 (see FIGS. 5 and 6) under a state in which the optical connectors 20a, 20b are detached from the connector fixing portions 31a, 31b of the holder 30. In contrast to this, in the above-mentioned embodiment, the boot 40 is provided with the rotation restricting portion. Thus, the optical connectors 20a, 20b can preferably be reversed upside down under a state in which the optical connectors 20a, 20b are fitted to the holder 30.

Further, in the above-mentioned embodiment, the duplex cable 10 having a substantially circular cross-sectional shape (see FIG. 11) is employed. However, this is not restrictive and a duplex cable having, for example, a spectacles-like cross-sectional shape (see FIG. 8) may be employed. As described above, the duplex cable having a substantially circular cross-sectional shape is preferred because the cable can be twisted more smoothly and the optical connector unit 1 can be rotated and fitted to the optical adapter more easily.

### REFERENCE SIGNS LIST

1 optical connector unit duplex cable
11, 12 bare fiber
20a (input) optical connector
20b (output) optical connector
21 ferrule
22 flange part
30 housing
24 locking lever
25 cap
30 holder
31 main body portion
31a, 31b connector fixing portion
32 cable fixing portion
32a, 32b guide groove
40 boot
41 main body portion
42 fixing portion
43 operation lever
43a pressing part
43b interlocking portion (rotation restricting portion)
50 gap

1. A duplex optical connector unit, which is fixed to a leading end of a duplex cable including a pair of optical fibers therein, comprising:
a pair of optical connectors, each of which includes a ferrule provided to a leading end of each of the pair of optical fibers, a housing for holding the ferrule, and a locking lever extending obliquely upward from a top surface of the housing toward a proximal end side, the pair of optical connectors each being provided at the leading end of each of the pair of optical fibers;
a holder, which includes connector fixing portions for fixing the pair of optical connectors, and a cable fixing portion for fixing the duplex cable; and
a boot, which includes a main body portion fitted to the holder and covering an outer periphery of the duplex cable, an operation lever extending obliquely upward from a top surface of the main body portion toward a leading end side, and a pressing part provided in the operation lever and located above the locking lever.

2. A duplex optical connector unit according to claim 1, wherein the boot includes a rotation restricting portion for restricting rotation of the pair of optical connectors relative to the holder.

3. A duplex optical connector unit according to claim 2, wherein the operation lever includes interlocking portions which engage with the locking lever on both sides in a width direction, the interlocking portions functioning as the rotation restricting portion.
